(19) United States
(12) Patent Application Publication
(10) Pub. No.: US 2006/0267470 A1
(43) Pub. Date: Nov. 30, 2006

(54) Electron emission display device having a cooling device and the fabricating method thereof

(76) Inventor: Byong Gon Lee, Yongin (KR)

Correspondence Address: CHRISTIE, PARKER & HALE, LLP, PO BOX 7068, PASADENA, CA, 91109-7068, US

(21) Appl. No.: 11/403,247

(22) Filed: Apr. 12, 2006

(30) Foreign Application Priority Data
May 26, 2005 (KR) 2005-44699

(51) Int. Cl. H01J 9/02

(52) U.S. Cl. 313/310

(57) ABSTRACT

An electron emission display device having internal cooling and a fabricating method of the device. The electron emission display device of the present invention comprises at least one first electrode pad provided on a substrate, at least one second electrode pad provided symmetrically to the first electrode pad with respect to a line along which the first electrode pad is located, and at a predetermined distance from this line, a first semiconductor formed so that one end of the first electrode pad and one end of the second electrode pad can be electrically connected to each other, and a second semiconductor formed at the other end of the first electrode pad. The durability of the device is enhanced by directly cooling the electron emitting portion.

### CROSS-REFERENCE TO RELATED APPLICATION

This application claims priority to and the benefit of Korean Patent Application No. 10-2005-0044699, filed on May 26, 2005, in the Korean Intellectual Property Office, the entire content of which is incorporated herein by reference.

### BACKGROUND

1. Field of the Invention

The present invention relates to an electron emission display device having a cooling device and a fabricating method of the electron emission display device. More particularly, the present invention relates to an electron emission display device having a cooling device and a fabricating method thereof which are capable of reducing heating of an electron emission portion by directly providing a cooling device to the electron emission display device.

2. Discussion of Related Art

Generally, a flat panel display (FPD) device includes two substrates and a sidewall disposed between the pair of substrates to form a sealed vessel, and suitable elements are provided in the vessel in order to display a desired image. In recent years, the importance of FPD device has remarkably increased due to the development of multimedia. In view of this, various FPD devices such as liquid crystal display (LCD) devices, plasma display panel (PDP) devices, electron emission display devices, and the like, have been developed.

Particularly, as the electron emission display device utilizes the luminescence of a fluorescent material by electron rays, similar to cathode ray tube (CRT), it is capable of realizing a flat panel display that is low in power consumption without distortion of image while maintaining features of CRTs. Thus, the electron emission display device is now gaining attention as a next generation display having wider viewing angle, faster response speed, higher definition, thinner structure, and the like.

Typically, the electron emission display devices are categorized into a hot cathode type or a cold cathode type depending on the type of electron source used in the device. Examples of the cold cathode electron emission display device include a field emitter array (FEA) type, a surface conduction emitter (SCE) type, a metal-insulator-metal (MIM) type, a metal-insulator-semiconductor (MIS) type, and a ballistic electron surface emitting (BSE) type.

The electron emission display device has a triode structure including a cathode electrode, an anode electrode and a gate electrode. The cathode which functions typically as a scan electrode is formed on the substrate, and an insulating layer with a hole and the gate electrode, which functions typically as a data electrode, are formed on the cathode electrode. An emitter acting as the electron emitting source is formed within the hole to be in contact with the cathode electrode.

In the above electron emission display device, a high electric field is concentrated at the emitter that discharges electrons through the quantum mechanical tunnel effect. As a result, electrons emitted from the emitter are accelerated by the electric field applied between the cathode electrode and the anode electrode before colliding against a RGB luminescent layer formed at the anode electrode, thereby causing the luminescent material to display the image.

FIG. 1 is an exploded perspective view showing the structure of a conventional image display apparatus, and FIG. 2 is a sectional view taken along the line I-I′ of FIG. 1. The conventional image display apparatus will be described with reference to FIG. 1 and FIG. 2. The image display apparatus 100 includes an image display panel 120 having a first substrate 121 and a second substrate 122 which are located with an interval in between, a heat sink 130 provided on a back face of the image display panel 120, a bottom cover 110 which covers a back face of the heat sink 130 and a side of the image display panel 120, and a top cover 140 which fixes a side and a corner of front face in the image display panel 120 and is to be coupled with the bottom cover 140.

In the image display panel 120, the first substrate 121, which acts as an electron emitting substrate, and the second substrate 122, which acts as an image forming substrate, are provided with a predetermined interval in between that is maintained in a vacuum state. Thus, a predetermined vacuum state can be maintained between the first substrate 121 and the second substrate 122. The image display panel 120 is provided with a supporting member 123 for supporting two substrates 121 and 122.

To the image display panel 120 having such a structure, a data driving unit 124a for supplying data signals and a scan driving unit 124b for supplying scan signals are connected, respectively.

In the data driving unit 124a and the scan driving unit 124b, a large quantity of heat can be generated due to a high current. As a result, the temperature of the whole of panel rises owing to the generated heat.

The heat generated during the driving of the image display panel 120 is dissipated by a heat sink 130 provided at the back face.

However, in the conventional image display apparatus, since the dissipation of heat is performed by only the contact of the heat sink which is limited to the effective emitting surface of the image display panel, it is difficult to dissipate enough heat in a portion where a large quantity of heat is actually generated.

### SUMMARY OF THE INVENTION

In view of the foregoing, the present invention provides an electron emission display device having a cooling device and a fabricating method for the device which are capable of increasing the lifetime of electron emitting portion by directly cooling the electron emitting portion.

An electron emission display device having internal cooling according to an aspect of the present invention comprises at least one first electrode pad provided on a substrate; at least one second electrode pad provided symmetrically to the first electrode pad with respect to a line along which the first electrode pad is located, and at a location disposed away by a distance from the line along which the first electrode pad is located; a first semiconductor formed in such a manner that one end of the first electrode pad and one end of the second electrode pad are electrically connected to each other; and a second semiconductor formed at the other end of the first electrode pad.

A method of a fabricating method of the electron emission display device according to another aspect of the present invention comprises etching two different electrically conductive material on a substrate to form a first electrode pad and a second electrode pad; and forming a first semiconductor and a second semiconductor such that the first electrode pad and the second electrode pad are electrically connected to each other.

In another embodiment an electron emission display device having internal cooling is presented that includes first electrode pads located on a substrate at predetermined intervals along a first direction, the first electrode pads each having two ends and second electrode pads located on the substrate at predetermined intervals along the first direction, the second electrode pads each having two ends. First semiconductors are formed on the substrate connecting one end of each one of the first electrode pads to one end of an adjacent one of the second electrode pads. Second semiconductors are formed on the substrate connecting the other end of each one of the first electrode pads to one end of another adjacent one of the second electrode pads. The first electrode pads are formed from a first conductive material and the second electrode pads are formed from a second conductive material different from the first conductive material. Embodiments of the present invention are capable of effectively reducing a heating of electron emitting portion by providing a cooling device directly to the electron emission display device.

### BRIEF DESCRIPTION OF THE DRAWINGS

The above aspects and features of the present invention will be more apparent by describing certain embodiments of the present invention with reference to the accompanying drawings.

FIG. 1 is an exploded perspective view showing a structural example of the conventional image display apparatus.

FIG. 2 is a sectional view taken along line I-I′ of FIG. 1.

FIG. 3 is a schematic cross-sectional view of an electron emission display device according to the present invention.

FIG. 4 is a schematic plan view of the electron emission display device provided with a cooling device according to the present invention.

FIG. 5 is an enlarged view in a portion of FIG. 4.

FIG. 6a is a schematic sectional view taken along line II-II′ of FIG. 4.

FIG. 6b is a schematic sectional view taken along line II-II′ of FIG. 4 according to a different embodiment.

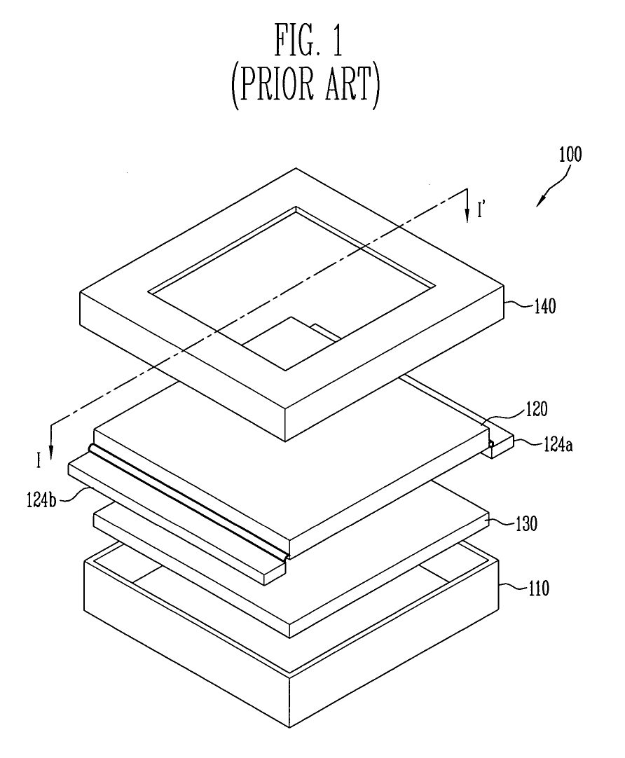

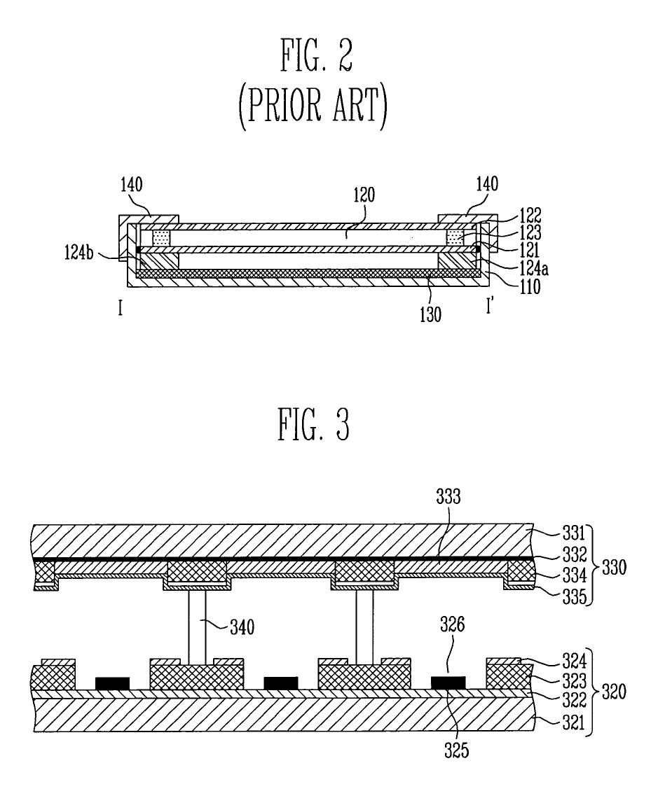

### DETAILED DESCRIPTION

Exemplary embodiments of the present invention will be described in greater detail with reference to the accompanying drawings. In the following description, same reference numerals are used for the same elements in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail. Hereinafter, embodiments of the present invention will be described with reference to the drawings.

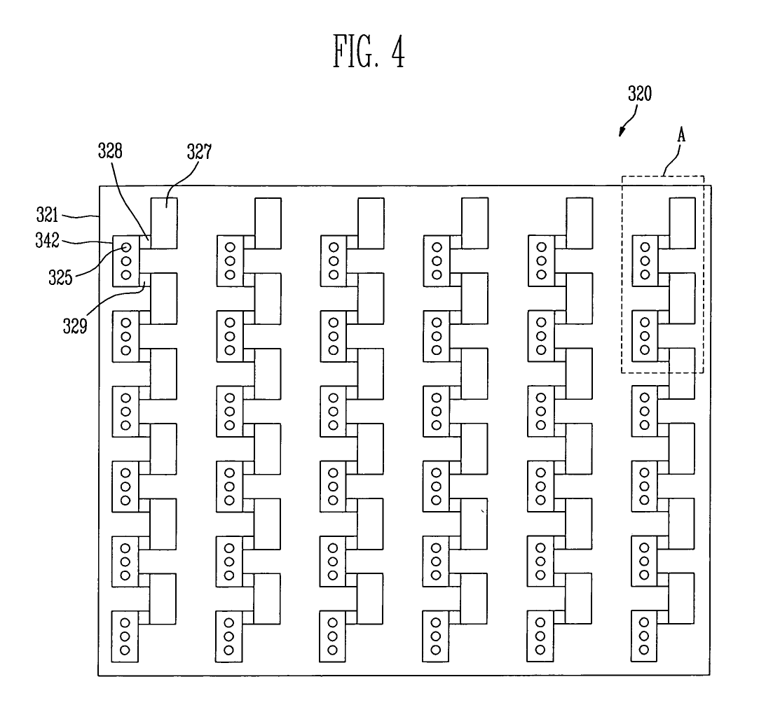

FIG. 3 is a schematic cross-sectional view of an electron emission display device according to the present invention.

As shown in FIG. 3, the electron emission display device 300 includes an electron emitting substrate 320 and an image forming substrate 330. Further, the electron emission display device 300 may be equipped with a spacer 340 to keep the interval between the electron emitting substrate 320 and the image forming substrate 330 constant.

The electron emitting substrate 320 emits electrons based on the electric field between cathode electrodes 322 and gate electrodes 324, and includes a rear substrate 321, cathode electrodes 322, an insulating layer 323, gate electrodes 324, and electron emitting portions 325.

The rear substrate 321 may be a glass or silicon substrate. When the rear substrate 321 is formed by back exposure using Carbon Nano Tube (CNT) paste, a transparent substrate such as glass can be used.

The cathode electrodes 322, to which data signals from the data driving unit or scan signals from the scan driving unit are supplied, can be formed at predetermined intervals, in a shape of a pad on the rear substrate 321. The cathode electrode 322 may be formed from a conductive material or from a transparent conductive material such as Indium Tin Oxide (ITO).

The insulating layer 323 is formed over the rear substrate 321 and the cathode electrode 322 to provide insulation between the cathode electrode 322 and the gate electrode 324. The insulating layer 323 can be formed of an insulating material, for example, a mixed glass material of PbO and SiO₂.

The gate electrodes 324 are disposed on the insulating layer 323 in a direction intersecting a direction of the cathode electrodes 322, in a prescribed shape, for example, in a striped pattern. Data signals from the data driving unit or scan signals from the scan driving unit are to be supplied to the gate electrodes 324. The gate electrodes 324 may be formed of an electrically conductive metal, for example, at least one metal selected from Au, Ag, Pt, Al, Cr, and alloys of these metals. The insulating layer 323 and the gate electrodes 324 include at least one first opening 326, at an area where the cathode electrodes 322 and the gate electrodes 324 cross over one another, to expose the cathode electrodes 322.

The electron emitting portion 325 is formed to be electrically connected to the cathode electrode 322 where the electrode 322 is exposed by the first opening 326. The electron emitting portion 325 may be formed of any material selected from the carbon Nano Tube, graphite Nano Tube, diamond, diamond-phase carbon or combination of these, or Nano wire made of Si or SiC.

The image forming substrate 330 emits light resulting from collision of electrons discharged from the electron emission substrate 320 to form and display the image. The image forming substrate 330 includes a front substrate 331, an anode electrode 332, a fluorescent material part 333, a light shielding film 334, and a metallic reflecting film 335.

The front substrate 331 may be formed of a transparent material, for example, a glass, so that light emitting from the fluorescent material 333 can be transmitted to the outside.

The anode electrode 332 may be formed of a transparent material, for example, an ITO, so that light emitting from the fluorescent material part 333 can be transmitted to the outside. The anode electrode 332 accelerates electrons discharged in the electron emission display device. To this end, a positive high voltage is applied to the anode electrode 332 to accelerate electrons toward the fluorescent material 333.

Fluorescent material 333 is selectively disposed at a predetermined interval on the anode electrode 332 and emits light by collision of electrons discharged from the electron emission substrate 320 against the fluorescent material. Fluorescent materials for emitting a green color is called a G fluorescent material and may include, for example, ZnS:Cu, Zn₂SiO₄:Mn, ZnS:Cu+Zn₂SiO₄:Mn, Gd₂O₂S:Tb, Y₃Al₅O₁₂:Ce, ZnS:Cu,Al, Y₂O₂S:Tb, ZnO:Zn, ZnS:Cu,Al+In₂O₃, LaPO₄:Ce,Tb,BaO.6Al₂O₃:Mn, (Zn,Cd)S:Ag, (Zn,Cd)S:Cu,Al,ZnS:Cu,Au,Al,Y₃(Al,Ga)₂O₁₂:Tb, Y₂SiO₅:Tb, or LaOCl:Tb. Also, B fluorescent material, or fluorescent materials for emitting a blue color, may include, for example, ZnS:Ag, ZnS:Ag,Al, ZnS:Ag,Ga,Al, ZnS:Ag,Cu,Ga,Cl, ZnS;Ag+In₂O₃, Ca₂B₅O₉Cl:Eu²⁺, (Sr,Ca,Ba,Mg),O(PO₄)₆Cl₂:Eu²⁺, (Sr,O)(PO₄)₆C₂:Eu²⁺, BaMgAl₁₆O₂₆:Eu²⁺, CoO, ZnS:Ag containing Al₂O₃, ZnS:Ag or Ga. Further, R fluorescent material, or fluorescent materials for emitting a red color, may include, for example, Y₂O₂S:Eu, Zn₃(PO₄)₂:Mn, Y₂O₃:Eu, YVO₄;Eu, (Y,Gd)BO₃:Eu), γ-Zn₃(PO₄)₂:Mn, (ZnCd)S:Ag, (ZnCd)S:Ag+In₂O₃, or Y₂O₂S:Eu containing Fe₂O₃.

The light shielding film 334 shields and absorbs outer light and prevents an optical crosstalk. The light shielding film 334 is disposed at predetermined intervals between the depositions of the fluorescent material part 333 to increase the contrast ratio.

The metallic reflecting film 335 is provided on the fluorescent material part 333 to effectively collect electrons discharged from the electron emission substrate 320. Further, the light which emits from the fluorescent material part 333 by collision of electrons is reflected by the front substrate 331, which increases the reflection efficiency. In an alternative embodiment, if the metallic reflecting film 335 functions as the anode electrode, forming a separate anode electrode (e.g., the anode electrode 332) becomes optional.

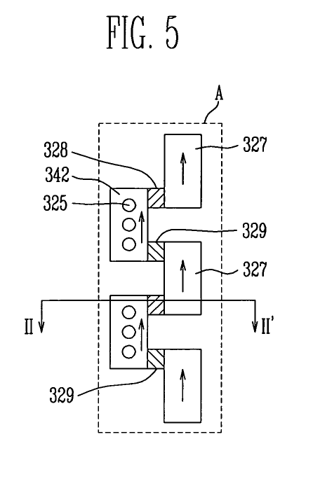

FIG. 4 is a schematic plan view showing an example of the structure of an electron emission display device provided with a cooling device according to the present invention, FIG. 5 is an enlarged view in a portion A of FIG. 4. As shown in FIG. 4 and FIG. 5, the electron emission display device provided with a cooling device includes at least one first electrode pad 342 provided along a line on a substrate 321. If the device includes more than one first electrode pad 342, they will be provided at predetermined intervals along this line. The device also includes at least one second electrode pad 327 provided symmetrically to the first electrode pads 342 with respect to the line along which the first electrode pads 342 are provided and at a predetermined distance from the line along which the first electrode pads 342 are located. The device also includes a first semiconductor 328 formed connecting one end of the first electrode pad 342 and one end of the second electrode pad 327. A second semiconductor 329 is formed at the other end of the first electrode pad 327.

The first electrode pad 342 is made of an electrically conductive material. A plurality of first electrode pads 342 may be located at predetermined distances along a line on the substrate 321. The first electrode pad 342 may be a cathode electrode 322 on which electron emitting portion 325 is to be formed.

A plurality of second electrode pads 327 may be provided along a line corresponding to the line where the first electrode pads 322 are formed on the substrate 321. The second electrode pad 327 may be formed from an electrically conductive material different from the material of the first electrode pad 342.

Therefore, the first electrode pad 342 and the second electrode pad 327 are made of electrically conductive material that are different from each other.

The first semiconductor 328 is formed to electrically connect one end of the first electrode pad 342 to one end of the second electrode pad 327. The second semiconductor 329 is formed to connect the other end of the first electrode pad 342 to one end of another second electrode pad 327. That is, the first semiconductor 328 and the second semiconductor 329 are formed so that the first electrode pad 342 and the second electrode pad 327 can be electrically connected to each other.

In an exemplary embodiment, the first semiconductor 328 may be P-type semiconductor, while the second semiconductor 329 may be N-type semiconductor. If electric current flows from the second semiconductor 329 to the first semiconductor 328, the first electrode pad 342 acts as a cooling pad, while the second electrode pad 327 acts as a heating pad. Then, the heat generated from the electron emitting portion 325 formed on the first electrode pad 342 can be transferred to the second electrode pad 327.

In the terminology used above, ambient heat is absorbed by the heating pad. Therefore, the heating pad causes the surrounding temperature to drop by absorbing the heat while it is heated itself through absorption of the ambient heat. Cooling pad, on the other hand, generates heat and is cooled itself by generating heat that can be subsequently absorbed by the heating pad.

More specifically, the first electrode pad 342 is made from a metal material that is different from the metal material forming the second electrode pad 327. If a semiconductor is electrically connected to these electrode pads 342, 327 to form a closed circuit and electric current flows through the semiconductor, a heat is generated at the contact or absorbed by the contact that is other than Joule's heat, which is equal to the product of resistance and a square of the current (RI²). This phenomenon is called the “Peltier effect”.

Therefore, the Peltier effect pertain to the emission and the absorption of heat generated when an electric current flows through a junction between two different kinds of materials. It is noteworthy that in the Peltier effect, when the electric current flows in one direction, heat is generated, on the other hand, when the electric current flows in the opposite direction, heat is absorbed. Thus, the Peltier effect is reversible. That is, as the electric current flows in the opposite direction, generation and absorption of heat is also reversed. For example, when both ends of a piece of iron and a piece of copper are connected and an electric current flows to the two junctions formed, in the one junction heat is discharged to outside, while in the other junction heat is absorbed from the outside to drop the ambient temperature.

Quantity of heat which can be absorbed and discharged by the Peltier effect is as follows:
|Qₚ|αab*Tj*I=π*I
where π=αab·Tj is the Peltier coefficient, I is the electric current flowing to the junction, αab is the relative thermocouple power of the two metals a and b based on ambient temperature, and |Qₚ| is the absolute value of quantity of heat generated per unit time.

Thus, if the first electrode pads 342 and the second electrode pads 327 are transposed in their positions and the electric current flows in the opposite direction to these two parts, the first electrode pads 342 function as the heating pad, while the second electrode pads 327 function as the cooling pad. The heat generated at the electron emitting portions formed on the second electrode pads 327 is transferred to the first electrode pads 342 where the heat can be reduced.

Hereinafter, a fabricating method of the electron emission display device having a cooling device will be described.

First, the electrically conductive material is etched on the substrate 321 to form the first electrode pad 342 and the second electrode pad 327. The first electrode pad 342 and the second electrode pad 327 are formed of materials that are different from each other. A metal material which forms the first electrode pads 342 is etched and patterned in the shape of pads with a predetermined distance between adjacent pads. Then, a metal material which forms the second electrode pads 327 is etched and patterned in the shape of pads with a predetermined distance in between adjacent pads. The first electrode pads 342 and the second electrode pads 327 are formed along a direction with a predetermined distance between adjacent pads 342, 327. Along this direction, the two types of pad 342, 327 are staggered with respect to a center line.

Then, either of the first electrode pad 342 and the second electrode pad 327 may become a cathode pad, and the cathode pad acts as a cathode electrode 322. The cathode electrode 322 is supplied with data signals from the data driving unit or scan signals from the scan driving unit. The cathode electrode 322 may be an electrical conductor or a transparent electrical conductor like ITO. Thereafter, the electron emitting portion 325 is formed on the cathode electrode 322.

Next, the first semiconductor 328 and the second semiconductor 329 are formed so that the first electrode pad 342 and the second electrode pad 327 are electrically connected to each other. The first semiconductor 328 may be made of P-type semiconductor, and the second semiconductor 329 may be made of N-type semiconductor. Alternatively, the first semiconductor 328 may be made of N-type semiconductor and the second semiconductor 329, of P-type semiconductor.

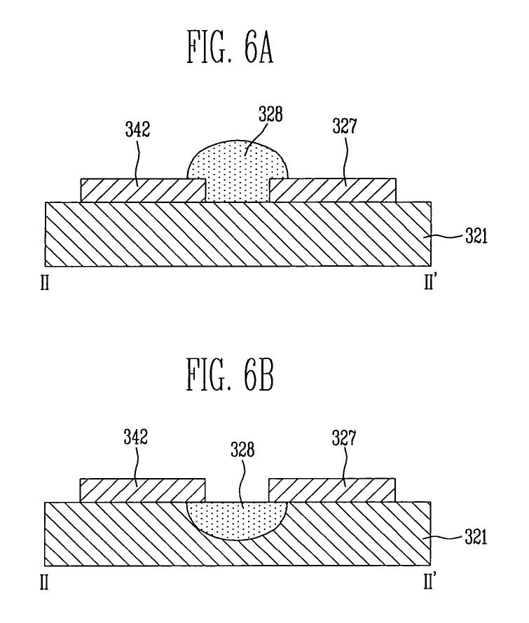

FIG. 6A is a schematic sectional view taken along line II-II′ of FIG. 5. As shown in FIG. 6A, the N-type or P-type first semiconductor 328 is formed to overlap both the first electrode pad 342 and the second electrode pad 327 forming a contact between the two pads. As a result, the first and second electrode pads 342, 327 can be electrically connected to each other via the first semiconductor 328. The sectional view of FIG. 6A is selected to pass through the first semiconductor 328. This sectional view also applies to a section passing through the second semiconductor 329.

FIG. 6A shows a method of forming the semiconductor material 328 between the first electrode pad 342 and the second electrode pad 327 by depositing the semiconductor material. In this method the contact created by the semiconductor material is formed to overlap both the first electrode pad 342 and the second electrode pad 327 and the area between the two pads 342, 327 on the substrate 321′. Thus, when electric current flows, it is possible to avoid a short circuit and to insure a good flow of current. The second semiconductor 329 may be formed using the same deposition method.

FIG. 6B is a schematic sectional view taken along line II-II′ of FIG. 5 for an alternative embodiment. As shown in FIG. 6B, the first semiconductor 328 is formed by doping N-type or P-type semiconductor material in the substrate 321 so that the first electrode pad 342 and the second electrode pad 327 can be electrically connected to each other. FIG. 6B can equally apply to a cross section taken through the second semiconductor 329.

In one embodiment, N-type or P-type semiconductor material is doped by a sputtering method in the area separating the first electrode pad 342 from the second electrode pad 327. The semiconductor material is formed to overlap the first electrode pad 342 and the second electrode pad 327. Thus, it is possible to avoid short circuit and to insure a good flow of current.

Thereafter, subsequent processes are performed for forming the remaining parts of the electron emission display device on the substrate including the above parts.

When the electric current flows into the first electrode pad 342 and the second electrode pad 327 of the electron emission display device, the heat generated at the first electrode pad 342 having the electron emitting portion 325 is transferred to the second electrode pad 327, so that the heat generated by the electron emitting portion 325 can be reduced. That is, by directly cooling the electron emitting portion 325, it is possible to prevent the overheating of the electron emitting portion 325, so that the lifetime of the device can be extended.

In the above-mentioned embodiments, the electron emitting portion 325 is formed on the first electrode pad 342 that may also be the cathode electrode 322. Consequently, the first electrode pad 342 serves as the cooling pad for the heat generated at the electron emission portion 325 and the second electrode pad 327 functions as the heating pad. However, the electron emitting portion 325 may be formed so that the second electrode pad 327 becomes the cathode pad for the cathode electrode 322. In that case, the electric current flows in an opposite direction and the second electrode pad 327 functions as a cooling pad, while the first electrode pad 342 functions as a heating pad.

As described, according to the present invention, by directly cooling the electron emitting portion 325, it is possible to prevent an overheating of the electron emitting portion 325. As a result, the lifetime of the device can be extended.

The foregoing embodiment are merely exemplary and are not to be construed as limiting the present invention. The present teachings can be readily applied to other types of apparatus. Also, the description of the embodiments of the present invention is intended to be illustrative, and not to limit the scope of the claims, and any alternatives, modifications, and variations as apparent to those skilled in the art. Therefore, although certain exemplary embodiments of the present invention have been shown and described, it would be appreciated by those skilled in the art that changes might be made to these embodiments without departing from the principles and spirit of the invention, the scope of which is defined in the claims and their equivalents.

What is claimed is:

1. An electron emission display device having internal cooling, comprising:
at least one first electrode pad provided on a substrate and located along a first line;
at least one second electrode pad provided on the substrate symmetrically to the at least one first electrode pad with respect to the first line and located at a distance from the first line;
a first semiconductor formed on the substrate and electrically connecting one end of the at least one first electrode pad to one end of the at least one second electrode pad; and
a second semiconductor formed on the substrate and electrically connected to the other end of the first electrode pad.

2. A device according to claim 1, wherein the second semiconductor is electrically connected to one end of another second electrode pad.

3. A device according to claim 1, wherein the first electrode pad is a cooling pad, and the second electrode pad is a heating pad.

4. A device according to claim 1, wherein the first electrode pad and the second electrode pad are formed of different metal materials.

5. A device according to claim 1, wherein the first semiconductor is P-type semiconductor and the second semiconductor is N-type semiconductor.

6. A device according to claim 1, wherein an electron emission element is formed on the first electrode pad.

7. A device according to claim 1 wherein electric current flows from the second semiconductor to the first semiconductor.

8. A device according to claim 1, wherein the first electrode pad and the second electrode pad are formed having transposed positions.

9. A device according to claim 8, wherein electric current flows from the first semiconductor to the second semiconductor.

10. A method for fabricating an electron emission display device having a cooling device, the method comprising:
forming a first electrode pad and a second electrode pad on a substrate by etching electrically conductive materials on the substrate; and
forming a first semiconductor and a second semiconductor, at least one of the first semiconductor or the second semiconductor electrically connecting the first electrode pad to the second electrode pad.

11. A method according to claim 10, wherein the first semiconductor is P-type semiconductor and the second semiconductor is N-type semiconductor.

12. A method according to claim 10, wherein forming the first semiconductor and the second semiconductor includes doping the substrate using N-type or P-type material, the N-type or P-type material overlapping the first electrode pad and the second electrode pad.

13. A method according to claim 10, wherein forming the first semiconductor and the second semiconductor includes doping N-type or P-type material such that the first electrode pad and the second electrode pad are electrically connected.

14. An electron emission display device having internal cooling, comprising:
first electrode pads located on a substrate at predetermined intervals along a first direction, the first electrode pads each having two ends;
second electrode pads located on the substrate at predetermined intervals along the first direction, the second electrode pads each having two ends;
first semiconductors formed on the substrate connecting one end of each one of the first electrode pads to one end of an adjacent one of the second electrode pads; and
second semiconductors formed on the substrate connecting the other end of each one of the first electrode pads to one end of another adjacent one of the second electrode pads,
wherein the first electrode pads are formed from a first conductive material and the second electrode pads are formed from a second conductive material different from the first conductive material.

15. The electron emission display device of claim 14,
wherein the first electrode pads are located along a first line,
wherein the second electrode pads are located along a second line extending parallel to the first line and located at a distance from the first line, and
wherein the first electrode pads are staggered with respect to the second electrode pads.

16. The electron emission display device of claim 14, further comprising: electron emitting portions formed in the first electrode pads.

17. The electron emission display device of claim 16, wherein a portion of a flow path for an electric current includes flowing from one of the second semiconductors to one of the first electrode pads to one of the first semiconductors to one of the second electrode pads to the outside of the electron emission display device.

18. The electron emission display device of claim 17, wherein the first electrode pads function as cooling pads by generating heat while cooling off, and the second electrode pads function as heating pads by absorbing heat generated by the first electrode pads hence heating up.

19. The electron emission display device of claim 14, wherein the first semiconductors and the second semiconductors are formed by doping the substrate between the first electrode pads and the second electrode pads at the two ends of the first electrode pads and the second electrode pads.

20. The electron emission display device of claim 19, wherein the first semiconductors and the second semiconductors overlap the first electrode pads and the second electrode pads.
